(19) United States
(12) Patent Application Publication
(10) Pub. No.: US 2021/0125088 A1
(43) Pub. Date: Apr. 29, 2021

(54) PRODUCT DETECTION DEVICE, METHOD, AND PROGRAM

(71) Applicant: NEC Corporation, Minato-ku, Tokyo (JP)

(72) Inventor: Yuya MATSUMOTO, Tokyo (JP)

(73) Assignee: NEC Corporation, Minato-ku, Tokyo (JP)

(21) Appl. No.: 16/981,857

(22) PCT Filed: Dec. 26, 2018
(86) PCT No.: PCT/JP2018/047771

§ 371 Date: Sep. 17, 2020

(30) Foreign Application Priority Data
Mar. 27, 2018 (JP) 2018-059485

(51) Int. Cl. G06N 5/04; G06N 20/00

(52) U.S. Cl. CPC G06N 5/04; G06N 20/00

(57) ABSTRACT

Provided is a product detection device capable of detecting a normal product deviated from a normal pattern from normal products determined to be normal. The training means 73 sequentially selects window data and trains a model for restoring latter part data from former part data by using a set of pairs of former part data and latter part data obtained from time series data of each of a plurality of normal products as training data. The difference calculation means 75 calculates a difference between latter part data and restored data for each normal product. The window data decision means 76 decides window data satisfying a predetermined condition based on a difference calculated for each normal product. The product detection means 77 detects a predetermined normal product from a plurality of normal products based on a difference for each normal product obtained based on the decided window data.

### TECHNICAL FIELD

The present invention relates to a product detection device, a product detection method, and a product detection program for detecting a product deviated from a normal pattern from products determined to be normal.

### BACKGROUND ART

There is a technique for automatically detecting an abnormality in an apparatus from time series data acquired from a sensor. For example, PTL 1 describes a system for performing abnormality determination on a monitoring target using sensor data that has been accumulated. PTL 1 also describes dividing time series data and segmenting segment data.

Moreover, there is a recursive neural network as a technique for automatically detecting an abnormality from time series data using machine learning. For detecting an anomaly by a recursive neural network, it is necessary to perform training using both abnormal data and normal data.

Moreover, PTL 2 describes an abnormality detection method of inferring a latent variable from input data, generating restored data from the latent variable based on a model trained preliminarily, and determining whether the input data is normal or not based on deviation between the input data and the restored data.

### CITATION LIST

### Patent Literature

PTL 1: International Publication No. WO2011/036809

PTL 2: International Publication No. WO2017/094267

### SUMMARY OF INVENTION

### Technical Problem

Even when products are determined to be normal in some inspection, variation occurs in quality. Therefore, there is a need to distinguish a product, which is deviated from a normal pattern, from products determined to be normal. This is because, even when a product is determined to be normal, the product deviated from a normal pattern may fail in the future, and it is desired to predict a product with such a possibility of failure.

However, it has been difficult to determine a product deviated from a normal pattern from products determined to be normal by a recursive neural network. This is because a set of products, from which a product deviated from a normal pattern is to be detected, are all products that are determined to be normal, and what is to be focused on to understand variation in quality has been often unclear. Therefore, it has been impossible to clearly define a value that indicates variation in quality. As a result, it has been difficult to determine a product deviated from a normal pattern from products determined to be normal.

Accordingly, it is an object of the present invention to provide a product detection device, a product detection method, and a product detection program capable of detecting a normal product deviated from a normal pattern from normal products determined to be normal.

### Solution to Problem

A product detection device according to the present invention is characterized by including: window data storage means that stores a plurality of pieces of window data, each window data being a combination of a size of a first window for extracting data from time series data of a normal product, a size of each of a second window and a third window for dividing data extracted using the first window into former part data and latter part data, and a slide size in sliding the first window; training means that trains a model for restoring latter part data from former part data by using a set of pairs of former part data and latter part data obtained using the first window, the second window, and the third window from time series data of each of a plurality of normal products as training data, window data is sequentially selected; restored data generation means that generates restored data of latter part data by applying former part data to the model for each pair of former part data and latter part data obtained based on the selected window data; difference calculation means that calculates a difference between latter part data and restored data obtained based on the selected window data for each normal product; window data decision means that decides window data satisfying a predetermined condition based on a difference calculated for each normal product; and detection means that detects a predetermined normal product from a plurality of normal products based on a difference for each normal product obtained based on window data decided by the window data decision means.

Moreover, a product detection method according to the present invention is characterized in that a computer including window data storage means that stores a plurality of pieces of window data, each of which is a combination of a size of a first window for extracting data from time series data of a normal product, a size of each of a second window and a third window for dividing data extracted using the first window into former part data and latter part data, and a slide size in sliding the first window, is configured to: train a model for restoring latter part data from former part data by using a set of pairs of former part data and latter part data obtained using the first window, the second window, and the third window from time series data of each of a plurality of normal products as training data, window data is sequentially selected, generate restored data of latter part data by applying former part data to the model for each pair of former part data and latter part data obtained based on the selected window data, calculate a difference between latter part data and restored data obtained based on the selected window data for each normal product, decide window data that satisfies a predetermined condition based on a difference calculated for each normal product, and detect a predetermined normal product from a plurality of normal products based on a difference for each normal product obtained based on the decided window data.

Moreover, a product detection program according to the present invention is a product detection program to be mounted on a computer including window data storage means that stores a plurality of pieces of window data, each of which is a combination of a size of a first window for extracting data from time series data of a normal product, a size of each of a second window and a third window for dividing data extracted using the first window into former part data and latter part data, and a slide size in sliding the first window, characterized by being capable of causing the computer to execute: a training process of training a model for restoring latter part data from former part data using a set of pairs of former part data and latter part data obtained using the first window, the second window, and the third window from time series data of each of a plurality of normal products as training data, window data is sequentially selected; a restored data generation process of generating restored data of latter part data by applying former part data to the model for each pair of former part data and latter part data obtained based on the selected window data; a difference calculation process of calculating a difference between latter part data and restored data obtained based on the selected window data for each normal product; a window data decision process of deciding window data that satisfies a predetermined condition based on the difference calculated for each normal product; and a detection process of detecting a predetermined normal product from a plurality of normal products based on a difference for each normal product obtained based on the window data decided in the window data decision process.

### Advantageous Effects of Invention

It is possible with the present invention to detect a normal product deviated from a normal pattern from normal products determined to be normal.

### BRIEF DESCRIPTION OF DRAWINGS

FIG. 1 It depicts a block diagram illustrating an example of a product detection device according to a first exemplary embodiment of the present invention.

FIG. 2 It depicts a schematic diagram illustrating a process in which a data segmentation unit segments data from time series data using a first window.

FIG. 3 It depicts a schematic diagram illustrating a process in which the data segmentation unit divides the segmented data into former part data and latter part data.

FIG. 4 It depicts a schematic diagram illustrating sliding of the first window.

FIG. 5 It depicts a flowchart illustrating an example of the process progress of the product detection device of the present invention.

FIG. 6 It depicts a flowchart illustrating an example of the process progress of step S102.

FIG. 7 It depicts a flowchart illustrating an example of the process progress of step S103.

FIG. 8 It depicts a schematic diagram illustrating training of a model for restoring latter part data.

FIG. 9 It depicts a flowchart illustrating an example of the process progress of step S104.

FIG. 10 It depicts a schematic diagram illustrating generation of restored data.

FIG. 11 It depicts a flowchart illustrating an example of the process progress of step S105.

FIG. 12 It depicts a schematic diagram illustrating cases where a difference between latter part data and restored data is small and large.

FIG. 13 It depicts a flowchart illustrating an example of the process progress of step S107.

FIG. 14 It depicts a schematic diagram illustrating an example of frequency distribution of product differences.

FIG. 15 It depicts a schematic diagram illustrating the difference between frequency distributions of product differences corresponding to two pieces of window data.

FIG. 16 It depicts a schematic diagram illustrating an example of coordinates (0, Y) and coordinates (x, y) corresponding to each window data.

FIG. 17 It depicts a flowchart illustrating an example of the process progress of step S108.

FIG. 18 It depicts a block diagram illustrating an example of a product detection device according to a second exemplary embodiment of the present invention.

FIG. 19 It depicts a schematic block diagram illustrating a configuration example of a computer according to each exemplary embodiment of the present invention.

FIG. 20 It depicts a block diagram illustrating an outline of a product detection device of the present invention.

### DESCRIPTION OF EMBODIMENTS

The following description will explain exemplary embodiments of the present invention with reference to the drawings. In the following description, a product determined to be normal is referred to as a normal product. It is assumed that whether a product is a normal product or not has been determined preliminarily. Moreover, a method of determining whether a product is a normal product or not is not particularly limited. The present invention detects a normal product deviated from a normal pattern from a plurality of normal products.

### Exemplary Embodiment 1

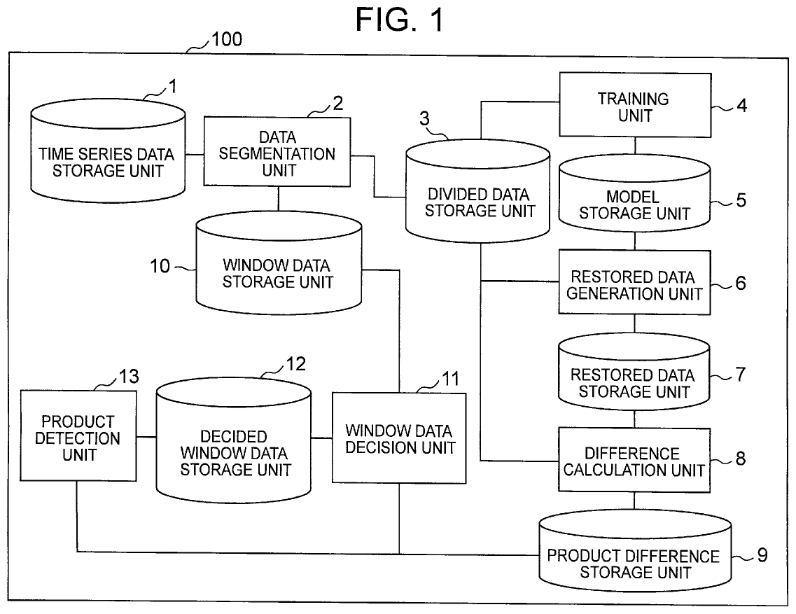

FIG. 1 depicts a block diagram illustrating an example of a product detection device according to the first exemplary embodiment of the present invention. A product detection device 100 according to the first exemplary embodiment of the present invention includes a time series data storage unit 1, a data segmentation unit 2, a divided data storage unit 3, a training unit 4, a model storage unit 5, a restored data generation unit 6, a restored data storage unit 7, a difference calculation unit 8, a product difference storage unit 9, a window data storage unit 10, a window data decision unit 11, a decided window data storage unit 12, and a product detection unit 13.

The time series data storage unit 1 is a storage device that stores time series data of a plurality of normal products. Time series data is data that represents change in a numerical value over time, and is, for example, data in which numerical values are associated with times arranged in the order of elapsed time. What this numerical value represents is not particularly limited. Time series data including numerical values according to the types of normal products may be preliminarily stored in the time series data storage unit 1. Moreover, time series data may be data obtained directly from a normal product, or may be data obtained from a sensor that monitors a normal product.

It is assumed that identification information is preliminarily assigned to each normal product, and identification information of a normal product is associated with time series data.

The window data storage unit 10 is a storage device that stores a plurality of pieces of window data. One piece of window data is a combination of the size of a first window, the size of a second window, the size of a third window, and the slide size (sliding amount) in sliding the first window.

The first window is a window for segmenting data from time series data. The second window and the third window are windows for dividing the data segmented using the first window into former part data and latter part data, respectively. The second window corresponds to the former part data, and the third window corresponds to the latter part data. The size of the first window is the sum of the size of the second window and the size of the third window.

It is to be noted that the expression “to segment data” can also be represented as “to extract data”.

The data segmentation unit 2 sequentially selects a plurality of pieces of window data stored in the window data storage unit 10 one by one. Then, the data segmentation unit 2 segments data from time series data of each of a plurality of normal products using the first window according to the selected window data. Furthermore, the data segmentation unit 2 divides the segmented data into former part data and latter part data using the second window and the third window according to the window data. The data segmentation unit 2 superposes the right end of the second window and the left end of the third window, and segments data from the data segmented using the first window by using the second window and the third window, so as to divide the data segmented using the first window into former part data and latter part data. Hereinafter, the data segmented using the first window may be referred to as segmented data.

It is assumed that identification information is preliminarily assigned to each window data, and each window data is stored in the window data storage unit 10 together with the identification information of the window data.

The data segmentation unit 2 repeats an operation of segmenting data from time series data of one normal product using the first window and dividing the segmented data into former part data and latter part data while sliding the first window with the slide size. Then, if the data segmentation unit 2 becomes unable to slide the first window, segmentation of data from the time series data is terminated.

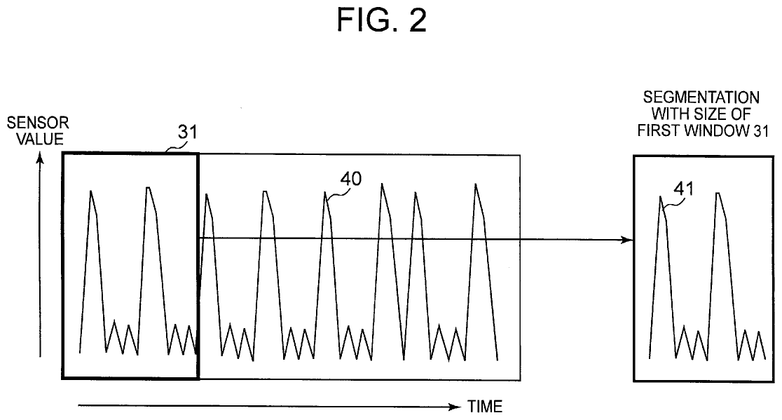

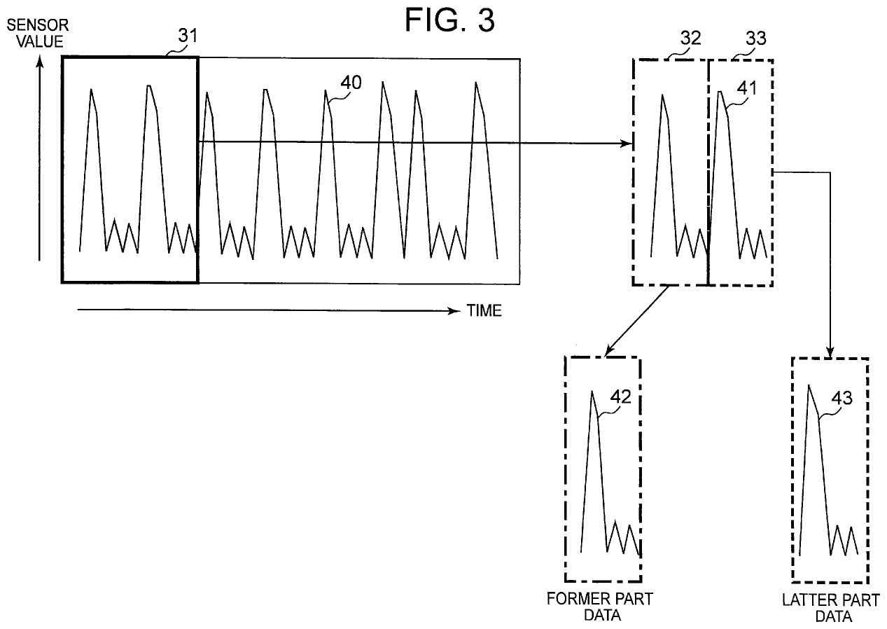

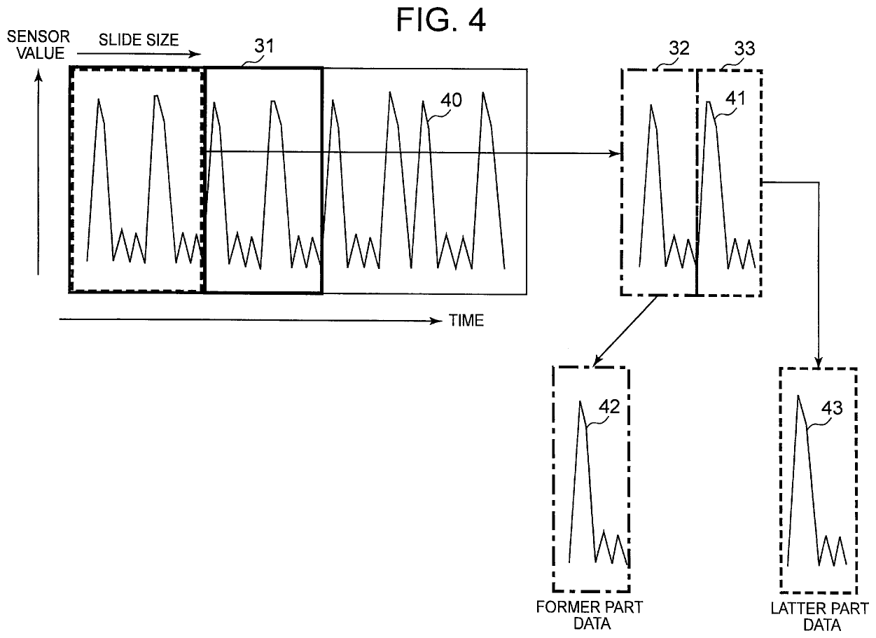

FIG. 2 depicts a schematic diagram illustrating a process in which the data segmentation unit 2 segments data from time series data using the first window. In the example illustrated in FIG. 2, it is to be noted that time series data 40 is data in which numerical values (sensor values) obtained by the sensor monitoring normal products are associated with times arranged in the order of elapsed time. This point is the same in FIGS. 3 and 4 described later. The data segmentation unit 2 segments data from the time series data 40 with the size of a first window 31. As a result, segmented data 41 is obtained.

FIG. 3 depicts a schematic diagram illustrating a process in which the data segmentation unit 2 divides the segmented data 41 into former part data and latter part data. The data segmentation unit 2 superposes the right end of a second window 32 and the left end of a third window 33, and segments data from the segmented data 41 with the size of the second window 32 and the size of the third window 33, so as to divide the segmented data 41 into former part data 42 and latter part data 43. In the drawings, it is to be noted that the second window 32 is drawn by dash-dotted lines and the third window 33 is drawn by broken lines.

FIG. 4 depicts a schematic diagram illustrating sliding of the first window. The data segmentation unit 2 slides the first window 31 in a time axis direction with the slide size according to the selected window data, segments the segmented data 41 from the time series data 40, and divides the segmented data 41 into the former part data 42 and the latter part data 43. The data segmentation unit 2 repeats this process until it becomes impossible to slide any first window in the time series data 40.

The data segmentation unit 2 executes this process for each of time series data of a plurality of normal products.

Moreover, when obtaining a pair of former part data 42 and latter part data 43, the data segmentation unit 2 causes the divided data storage unit 3 to store the pair in association with the identification information of the selected window data, and the identification information of a normal product corresponding to the time series data to be processed.

The divided data storage unit 3 is a storage device that stores a set of pairs of former part data 42 and latter part data 43.

The training unit 4 trains (generates) a model for restoring latter part data from former part data by machine learning by using a set of pairs of former part data 42 and latter part data 43 obtained based on the window data most recently selected by the data segmentation unit 2 (i.e., a set of pairs of former part data 42 and latter part data 43 associated with identification information of the most recently selected window data) as training data. The training unit 4 causes the model storage unit 5 to store the generated model in association with the identification information of the most recently selected window data.

The model storage unit 5 is a storage device that stores the model generated by the training unit 4.

The restored data generation unit 6 reads the model associated with the identification information of the most recently selected window data from the model storage unit 5, and reads all pairs of former part data and latter part data associated with the identification information of the window data from the divided data storage unit 3. Then, the restored data generation unit 6 restores latter part data by applying former part data to the model for each pair of former part data and latter part data. The restored latter part data is referred to as restored data. That is, the restored data generation unit 6 generates restored data of latter part data by applying former part data to the model for each pair of former part data and latter part data. The restored data generation unit 6 executes this process for each normal product (in other words, for each identification information of each normal product). The restored data generation unit 6 causes the restored data storage unit 7 to store the generated restored data in association with the identification information of the most recently selected window data and the identification information of the normal product.

The restored data storage unit 7 is a storage device that stores the restored data generated by the restored data generation unit 6.

The difference calculation unit 8 reads each latter part data associated with the identification information of the most recently selected window data from the divided data storage unit 3, and reads each restored data corresponding to each latter part data from the restored data storage unit 7. Restored data corresponding to latter part data is restored data generated based on former part data paired with the latter part data.

Then, the difference calculation unit 8 calculates a difference between the latter part data and the restored data for each normal product (in other words, for each identification information of each normal product). As described above, the data segmentation unit 2 generates a pair of former part data and latter part data while sliding the first window. Therefore, there are a plurality of pieces of latter part data for one normal product, and there is restored data for each of the plurality of pieces of latter part data. That is, there are a plurality of pairs of latter part data and restored data for one normal product. Therefore, the difference calculation unit 8 first calculates a plurality of differences between latter part data and restored data for one normal product. At this time, the difference calculation unit 8 calculates a difference as a numerical value. For example, for calculating a difference from a pair of latter part data and restored data, the difference calculation unit 8 may calculate an average value of the square of the difference between numerical values at the same time as a difference between the latter part data and the restored data. However, a method of calculating a difference as a numerical value is not limited to this method, and a difference may be calculated by other methods.

The difference calculation unit 8 calculates a plurality of differences between latter part data and restored data for one normal product, and then derives one difference corresponding to the normal product based on the plurality of differences. For example, the difference calculation unit 8 may calculate an average value of the plurality of differences and define the average value as one difference corresponding to the normal product. Moreover, for example, the difference calculation unit 8 may specify a maximum value of the plurality of differences and define the maximum value as one difference corresponding to the normal product. Hereinafter, one difference corresponding to one normal product derived based on a plurality of differences will be referred to as a product difference.

As described above, the difference calculation unit 8 calculates a plurality of differences between latter part data and restored data for each normal product, and derives a product difference based on the plurality of differences. The difference calculation unit 8 causes the product difference storage unit 9 to store the product difference in association with the identification information of the most recently selected window data and the identification information of the normal product.

The product difference storage unit 9 is a storage device that stores the product difference derived by the difference calculation unit 8.

The window data decision unit 11 decides one piece of window data that satisfies a predetermined condition from a plurality of pieces of window data stored in the window data storage unit 10 based on the product difference derived for each normal product. Details of the process in which the window data decision unit 11 decides window data will be described later. The window data decision unit 11 causes the decided window data storage unit 12 to store the decided window data.

The decided window data storage unit 12 is a storage device that stores the window data decided by the window data decision unit 11.

The product detection unit 13 reads the window data decided by the window data decision unit 11 from the decided window data storage unit 12. Then, the product detection unit 13 detects a predetermined normal product from a plurality of normal products based on a product difference for each normal product obtained based on the window data. More specifically, the product detection unit 13 selects product differences, the number of which corresponds to a predetermined ratio (e.g., 5%) to the number of normal products, from among product differences for each normal product obtained based on the window data in descending order of product difference, and detects normal products corresponding to the selected product differences.

It can be said that the product detection unit 13 detects normal products having large product differences. Therefore, it can be said that a normal product detected by the product detection unit 13 is a normal product deviated from the normal pattern.

The data segmentation unit 2, the training unit 4, the restored data generation unit 6, the difference calculation unit 8, the window data decision unit 11, and the product detection unit 13 are, for example, implemented by a Central Processing Unit (CPU) of a computer that operates according to a product detection program. In this case, the CPU may read the product detection program from a program recording medium such as a program storage device of a computer, and operate as the data segmentation unit 2, the training unit 4, the restored data generation unit 6, the difference calculation unit 8, the window data decision unit 11, and the product detection unit 13 according to the program.

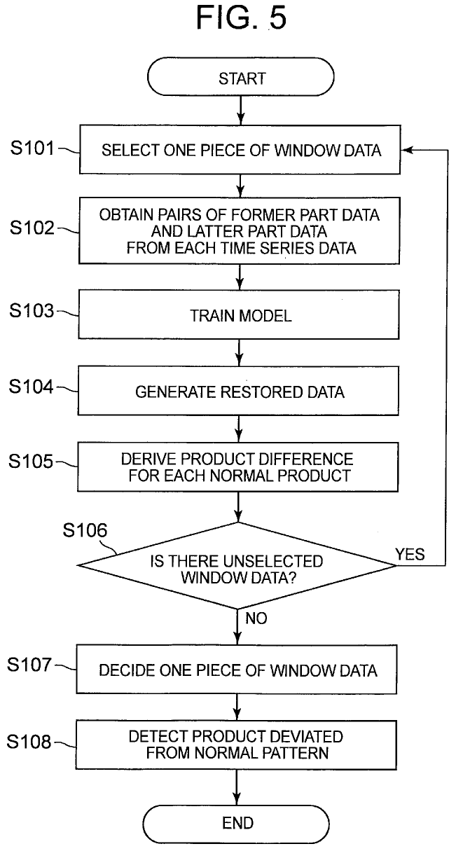

Next, the process progress of the present invention will be described. FIG. 5 depicts a flowchart illustrating an example of the process progress of the product detection device 100 of the present invention. In the following description, the description of the matters already described will be appropriately omitted.

First, the data segmentation unit 2 selects one piece of window data that has not been selected from among a plurality of pieces of window data stored in the window data storage unit 10, and reads the window data (step S101).

Next, the data segmentation unit 2 obtains pairs of former part data and latter part data from each time series data (step S102).

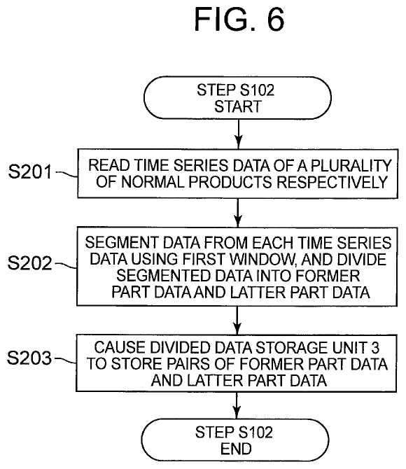

FIG. 6 depicts a flowchart illustrating an example of the process progress of step S102. In step S102, the data segmentation unit 2 reads time series data of a plurality of normal products respectively from the time series data storage unit 1 (step S201).

Then, the data segmentation unit 2 segments data from each time series data using the first window, and divides the segmented data into former part data and latter part data (step S202). Specifically, in step S202, the data segmentation unit 2 performs the following process for each time series data. The data segmentation unit 2 segments data from time series data with the size of the first window according to the selected window data. Then, the data segmentation unit 2 superposes the right end of the second window and the left end of the third window, and segments data from the data (segmented data) with the size of the second window and the size of the third window, so as to divide the segmented data into former part data and latter part data. Furthermore, the data segmentation unit 2 slides the first window with the slide size according to the selected window data, and repeats the same process. When it becomes impossible to slide first window in the time series data, the process is terminated.

The data segmentation unit 2 causes the divided data storage unit 3 to store each of the pairs of former part data and latter part data obtained in step S202 (step S203). At this time, the data segmentation unit 2 causes the divided data storage unit 3 to store each pair of former part data and latter part data in association with the identification information of the selected window data and the identification information of the normal product corresponding to the time series data to be processed.

In step S203, step S102 ends.

Following step S102, the training unit 4 trains a model for restoring latter part data from former part data (step S103).

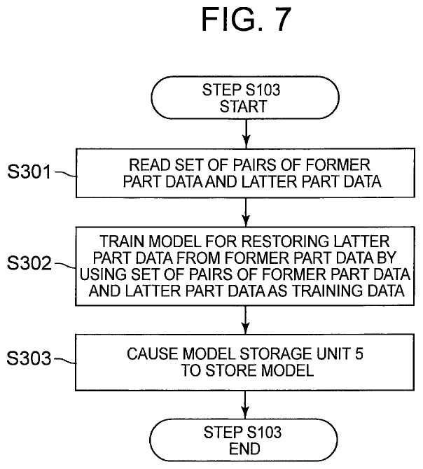

FIG. 7 depicts a flowchart illustrating an example of the process progress of step S103.

In step S103, the training unit 4 reads a set of pairs of former part data and latter part data associated with the identification information of the window data selected in the most recent step S101 (see FIG. 5) from the divided data storage unit 3 (step S301).

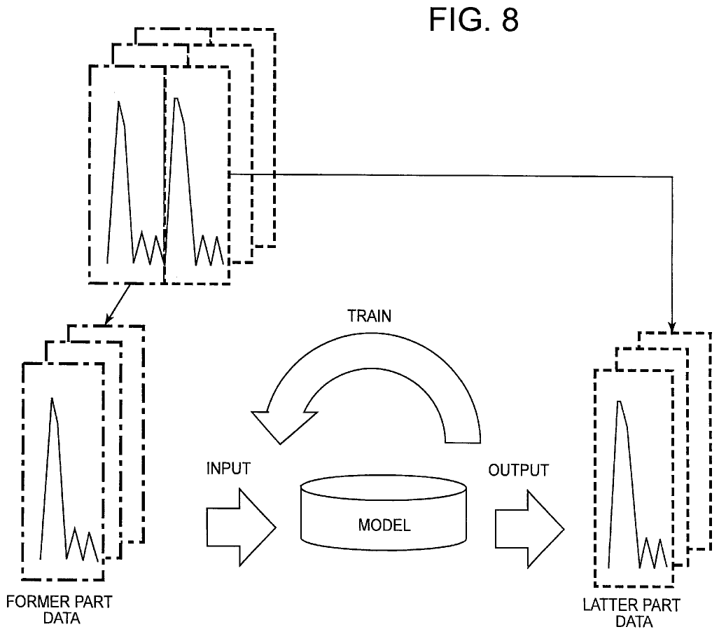

Next, the training unit 4 trains a model for restoring latter part data from former part data by machine learning by using a set of pairs of former part data and latter part data as training data (step S302). FIG. 8 depicts a schematic diagram illustrating training of a model for restoring latter part data.

In step S302, the training unit 4 may use, as a machine learning method, a method capable of reproducing an input, such as an automatic encoder. Deep learning is an example of this method. The training unit 4 may generate a model for restoring latter part data from former part data by deep learning.

Next, the training unit 4 causes the model storage unit 5 to store the model generated in step S302 in association with the identification information of the window data selected in the most recent step S101 (see FIG. 5) (step S303).

In step S303, step S103 ends.

Following step S103, the restored data generation unit 6 generates restored data (step S104).

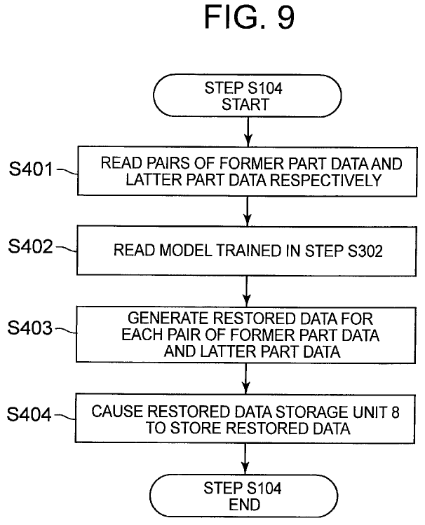

FIG. 9 depicts a flowchart illustrating an example of the process progress of step S104. In step S104, the restored data generation unit 6 reads all pairs of former part data and latter part data associated with the identification information of the window data selected in the most recent step S101 (see FIG. 5) from the divided data storage unit 3 (step S401).

Next, the restored data generation unit 6 reads a model associated with the identification information of the window data from the model storage unit 5 (step S402). This model is the model trained in the most recent step S302.

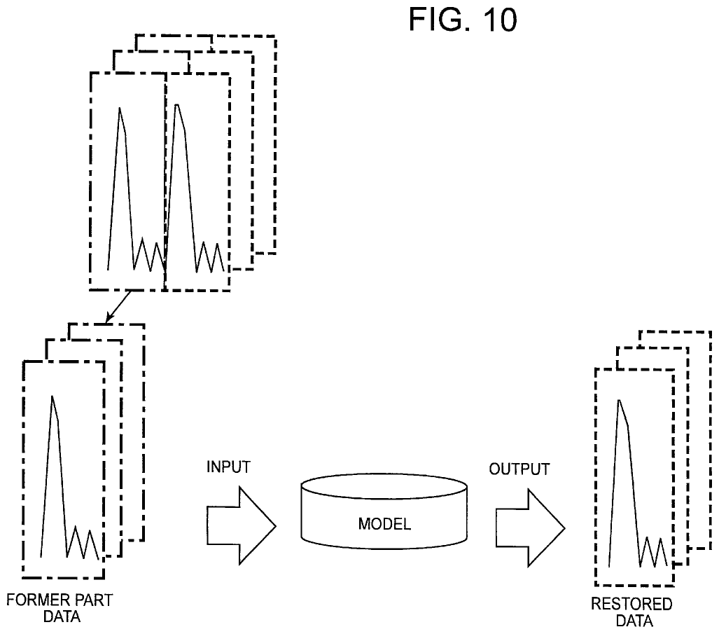

Next, the restored data generation unit 6 generates restored data of latter part data by applying the former part data to the model for each pair of former part data and latter part data read in step S401 (step S403). FIG. 10 depicts a schematic diagram illustrating generation of restored data. The restored data generation unit 6 executes generation of restored data for each normal product (in other words, for each identification information of each normal product).

Next, the restored data generation unit 6 causes the restored data storage unit 7 to store the generated restored data in association with the identification information of the window data selected in the most recent step S101 (see FIG. 5) and the identification information of the normal product (step S404).

In step S404, step S104 ends.

Following step S104, the difference calculation unit 8 derives a product difference for each normal product (step S105).

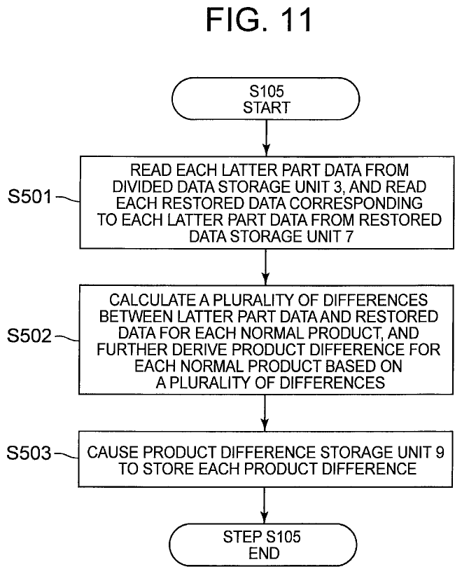

FIG. 11 depicts a flowchart illustrating an example of the process progress of step S105. In step S105, the difference calculation unit 8 reads each latter part data associated with the identification information of the window data selected in the most recent step S101 (see FIG. 5) from the divided data storage unit 3, and reads each restored data corresponding to each latter part data from the restored data storage unit 7 (step S501).

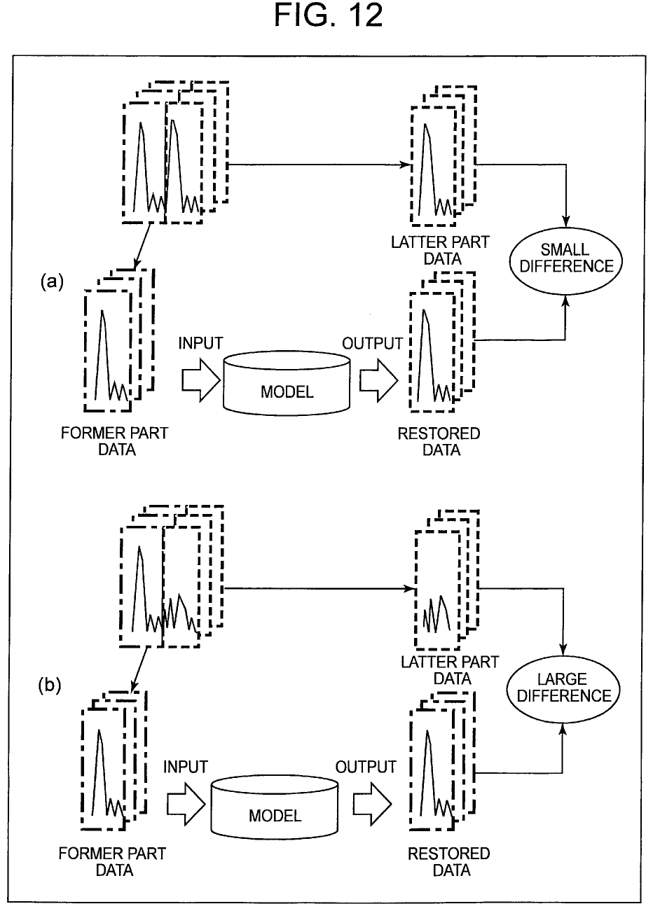

Next, the difference calculation unit 8 calculates a plurality of differences between latter part data and restored data for each normal product (in other words, for each identification information of each normal product). For obtaining a difference from a pair of latter part data and restored data, the difference calculation unit 8 calculates, for example, an average value of the square of the difference between numerical values at the same time as a difference between the latter part data and the restored data. FIG. 12 depicts a schematic diagram illustrating cases where a difference between latter part data and restored data is small and large. FIG. 12(a) illustrates a case where a difference between latter part data and restored data is small. In a case where the latter part data can be anticipated from the model, the difference will be small. FIG. 12(b) illustrates a case where a difference between latter part data and restored data is large. In a case where the latter part data cannot be anticipated from the model, the difference will be large.

The difference calculation unit 8 further derives a product difference for each normal product based on a plurality of differences (step S502). For deriving a product difference based on a plurality of differences for one normal product, the difference calculation unit 8 may calculate, for example, an average value of the plurality of differences and define the average value as the product difference of the normal product. Moreover, for example, the difference calculation unit 8 may specify a maximum value of the plurality of differences and define the maximum value as the product difference of the normal product.

The difference calculation unit 8 causes the product difference storage unit 9 to store the product difference derived for each normal product (step S503). At this time, the difference calculation unit 8 causes the product difference storage unit 9 to store each product difference in association with the identification information of the window data selected in the most recent step S101 (see FIG. 5) and the identification information of the normal product.

In step S503, step S105 ends.

Following step S105, whether there is window data that has not been selected in step S101 among a plurality of pieces of window data stored in the window data storage unit 10 or not is determined (step S106).

When there is unselected window data (Yes in step S106), the product detection device 100 repeats the processes from step S101.

When there is no unselected window data (No in step S106), the window data decision unit 11 decides one piece of window data that satisfies a predetermined condition based on the product difference derived for each normal product (step S107). In step S107, the window data decision unit 11 selects one piece of window data suitable for distinguishing between a normal product deviated from the normal pattern and a normal product not deviated from the normal pattern.

Through repeated processing of steps S101 to S106, the product difference of each normal product is derived for each window data and stored in the product difference storage unit 9.

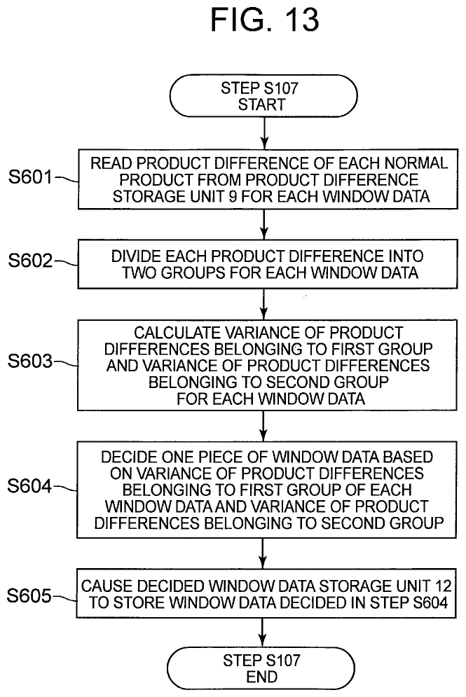

FIG. 13 depicts a flowchart illustrating an example of the process progress of step S107.

In step S107, the window data decision unit 11 first reads the product difference of each normal product from the product difference storage unit 9 for each window data (in other words, for each identification information of each window data) (step S601).

Next, the window data decision unit 11 divides each product difference for each window data into two groups, that is, a group having a larger product difference and a group having a smaller product difference (step S602). The group having a larger product difference is referred to as a first group, and the group having a smaller product difference is referred to as a second group.

In step S602, the window data decision unit 11 selects product differences, the number of which corresponds to a predetermined ratio (e.g., 5%) to the number of normal products, from among product differences derived one by one for each normal product in descending order of product difference, and defines that the selected product differences belong to the first group. Moreover, the window data decision unit 11 defines that product differences other than the selected product differences belong to the second group. Although a case where the above predetermined ratio is 5% will be described hereinafter as an example, the above predetermined ratio is not limited to 5%. In this example, 5% of the total product differences belong to the first group, and 95% belong to the second group.

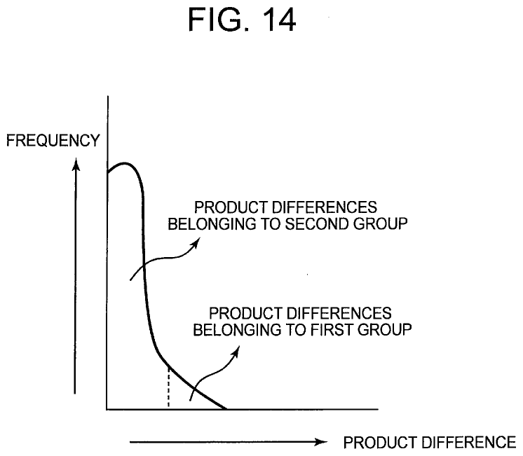

FIG. 14 illustrates an example of frequency distribution of product differences of a case where product differences are divided into the first group and the second group as described above. FIG. 14 illustrates the frequency distribution of product differences of a case where the product differences follow a normal distribution.

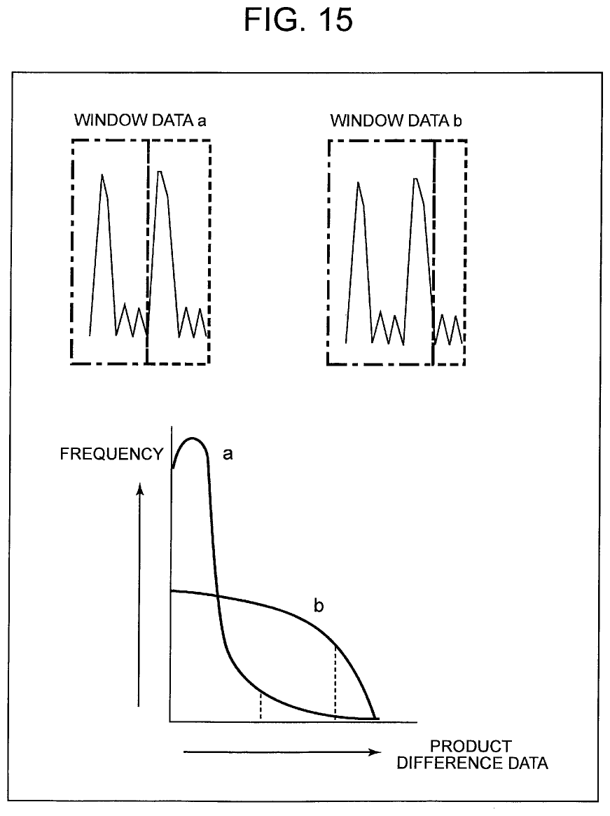

When the window data selected in step S101 is different, a product difference to be derived is also different. Therefore, when the window data is different, the frequency distribution of product differences is also different. FIG. 15 depicts a schematic diagram illustrating the difference between frequency distributions of product differences corresponding to two pieces of window data. All normal products have been previously determined to be normal. Therefore, product differences for most normal products are expected to be close to zero. In the example illustrated in FIG. 15, the frequency of product differences having values far from zero is large in the frequency distribution of product differences corresponding to the window data “b”. Therefore, the window data “b” illustrated in FIG. 15 is not appropriate for detecting a normal product deviated from the normal pattern.

Moreover, window data having all product differences close to zero is not appropriate for detecting a product deviated from the normal pattern. This is because if all product differences are values close to zero, it is impossible to distinguish between a product difference of a normal product deviated from the normal pattern and a product difference of a normal product not deviated from the normal pattern.

From the above, a frequency distribution in which there are many product differences having values close to zero and there are also product differences having values far from zero is preferable for detecting a normal product deviated from the normal pattern. For example, it is preferable to obtain a frequency distribution (frequency distribution of product differences) corresponding to the window data “a” illustrated in FIG. 15.

The window data decision unit 11 decides window data, for which such a preferable frequency distribution is obtained, by a process described below.

After step S602, the window data decision unit 11 calculates the variance of product differences belonging to the first group and the variance of product differences belonging to the second group for each window data (in other words, for each identification information of each window data) (step S603).

Furthermore, the window data decision unit 11 decides one piece of window data based on the variance of product differences belonging to the first group and the variance of product differences belonging to the second group in each window data (step S604).

In step S604, the window data decision unit 11 defines the maximum value (which will be referred to as Y) of the variance of product differences belonging to the first group for each window data as an ideal value of the variance of product differences belonging to the first group. Moreover, the window data decision unit 11 defines zero as an ideal value of the variance of product differences belonging to the second group. Then, the window data decision unit 11 decides window data based on the difference between the variance of product differences belonging to the first group and the ideal value Y of the variance, and the difference between the variance of product differences belonging to the second group and the ideal value (0) of the variance. Here, the window data decision unit 11 specifies one piece of window data such that the variance of product differences belonging to the first group and the variance of product differences belonging to the second group respectively become close to ideal values.

The above operation will be described more specifically. The maximum value of the variance of product differences belonging to the first group for each window data will be represented as Y. Moreover, the variance of product differences belonging to the first group corresponding to one piece of window data will be represented as y, and the variance of product differences belonging to the second group corresponding to the window data will be represented as x. The window data decision unit 11 calculates the distance (e.g., Euclidean distance) between coordinates (0, Y) and coordinates (x, y) for each window data, and decides window data satisfying a condition that the distance is the minimum.

For example, assume that there are three pieces of window data A, B, and C. Assume that the variance of product differences belonging to the first group corresponding to the window data A is “10”, and the variance of product differences belonging to the second group is “3”. Moreover, assume that the variance of product differences belonging to the first group corresponding to the window data B is “11”, and the variance of product differences belonging to the second group is “2”. Moreover, assume that the variance of product differences belonging to the first group corresponding to the window data C is “12”, and the variance of product differences belonging to the second group is “4”.

In this example, the maximum value Y of the variances of product differences belonging to the first group is “12”. Therefore, the ideal value of the variance of product differences belonging to the first group is “12”. Moreover, the ideal value of the variance of product differences belonging to the second group is “0”. Therefore, the above coordinates (0, Y) are (0, 12). Moreover, the above coordinates (x, y) corresponding to the window data A are (3, 10).

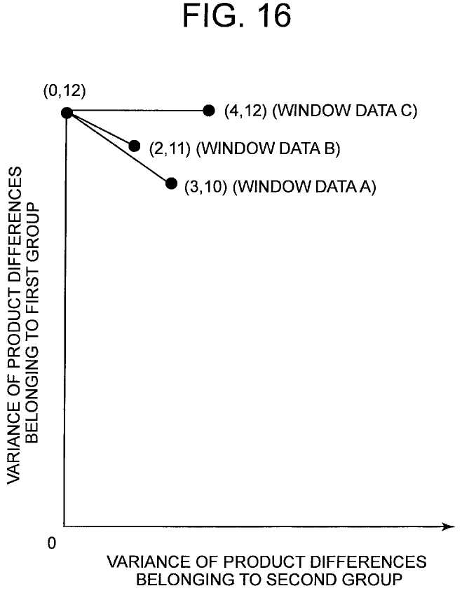

The above coordinates (x, y) corresponding to the window data B are (2, 11). The coordinates (x, y) of the above coordinates corresponding to the window data C are (4, 12). FIG. 16 depicts a schematic diagram illustrating an example of coordinates (0, Y) and coordinates (x, y) corresponding to each window data.

The window data decision unit 11 calculates the distance between coordinates (0, 12) and coordinates (x, y) for each window data, and decides window data satisfying a condition that the distance is the minimum. Since the coordinates having the smallest distance from coordinates (0, 12) are (2, 11), the window data decision unit 11 in this example decides “window data B” as window data satisfying a condition that the distance from (0, 12) is the minimum.

After step S604, the window data decision unit 11 causes the decided window data storage unit 12 to store the window data decided in step S604 together with the identification information thereof (step S605).

In step S605, step S107 ends.

Following step S107, the product detection unit 13 detects a normal product deviated from the normal pattern from a plurality of normal products based on each product difference obtained based on the window data decided in step S107 (step S108).

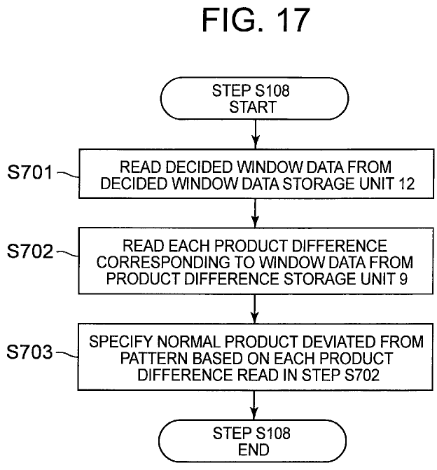

FIG. 17 depicts a flowchart illustrating an example of the process progress of step S108. In step S108, the product detection unit 13 reads the window data decided in step S107 from the decided window data storage unit 12 (step S701).

Next, the product detection unit 13 reads each product difference corresponding to the window data from the product difference storage unit 9 (step S702).

The product detection unit 13 specifies a normal product deviated from the pattern based on each product difference read in step S702 (step S703). In step S703, the product detection unit 13 selects product differences, the number of which corresponds to a predetermined ratio (e.g., 5%) to the number of normal products, from among product differences read in step S702 in descending order of product difference, and specifies normal products corresponding to the selected product differences.

It can be said that the normal products specified in step S703 are normal products deviated from the normal pattern.

According to the present exemplary embodiment, a plurality of pieces of window data are set, and the product detection device 100 derives a product difference of each normal product for each window data. Then, the product detection device 100 decides window data suitable for detecting a normal product deviated from the normal pattern. Specifically, the product detection device 100 decides, from a plurality of pieces of window data, window data that provides a frequency distribution, in which the number of product differences having values close to zero is large and there is also a product difference having a value far from zero, as the frequency distribution of product differences. In each product difference corresponding to the decided window data, the number of product differences having values close to zero is large, and there is also a product difference having a value far from zero. It can be said that a product difference having a value far from zero is deviated from the normal pattern. Then, the product detection unit 13 specifies a product difference having a value that is far from zero in this way. Therefore, it is possible with the present exemplary embodiment to detect a normal product deviated from the normal pattern from normal products that have been determined to be normal in some inspection.

### Exemplary Embodiment 2

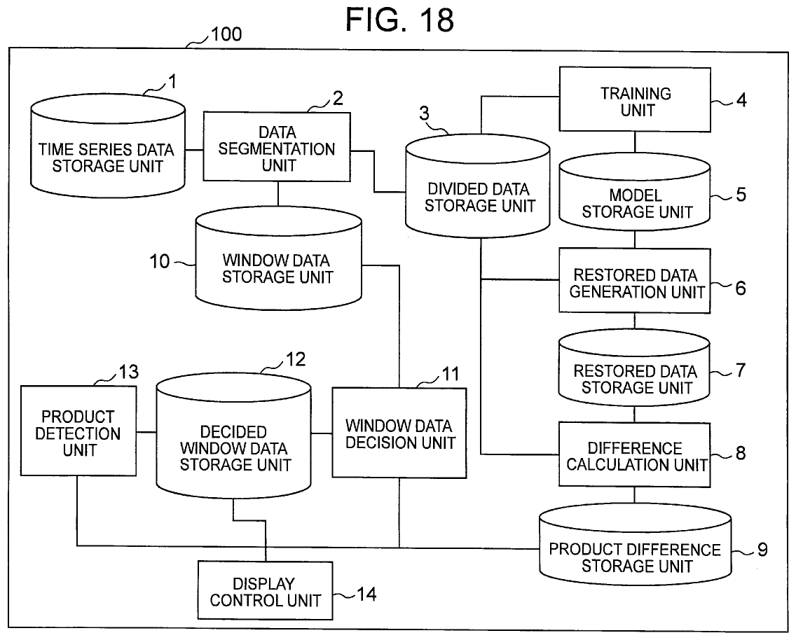

FIG. 18 depicts a block diagram illustrating an example of a product detection device according to the second exemplary embodiment of the present invention. Elements similar to the elements illustrated in FIG. 1 are denoted by the same reference numerals as those in FIG. 1, and explanation thereof will be omitted. A product detection device 100 according to the second exemplary embodiment of the present invention further includes a display control unit 14 in addition to the elements included in the product detection device 100 (see FIG. 1) of the first exemplary embodiment.

The display control unit 14 causes a display device (not shown in FIG. 18) to display a frequency distribution of product differences for each window data. For example, the display control unit 14 displays the frequency distribution of product differences illustrated in FIG. 14 regarding one piece of window data on the display device. The display control unit 14 similarly displays the frequency distribution of the product differences regarding other window data on the display device.

The display control unit 14 displays the frequency distribution of product differences for each window data on the display device, so that the user can visually confirm the distribution of product differences for each window data.

Moreover, the display control unit 14 may cause the display device to display window data stored in the decided window data storage unit 12. In this case, the user can visually confirm the window data decided by the window data decision unit 11.

Moreover, the display control unit 14 may cause the display device to display the identification information of the normal product detected by the product detection unit 13 (normal product specified by the product detection unit 13 in step S703). In this case, the user can visually confirm a normal product determined to be deviated from the normal pattern.

The display control unit 14 is implemented by, for example, a CPU of a computer that operates according to a product detection program. In this case, the CPU may read the product detection program from a program recording medium such as a program storage device of a computer, and operate as the data segmentation unit 2, the training unit 4, the restored data generation unit 6, the difference calculation unit 8, the window data decision unit 11, the product detection unit 13, and the display control unit 14 according to the program.

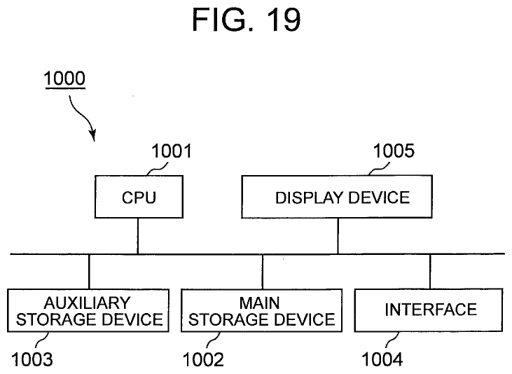

FIG. 19 depicts a schematic block diagram illustrating a configuration example of a computer according to each exemplary embodiment of the present invention. A computer 1000 includes a CPU 1001, a main storage device 1002, an auxiliary storage device 1003, an interface 1004, and a display device 1005.

The product detection device 100 according to each exemplary embodiment of the present invention is mounted on the computer 1000. The operation of the product detection device 100 is stored in the auxiliary storage device 1003 in the form of a product detection program. The CPU 1001 reads the product detection program from the auxiliary storage device 1003, develops the program in the main storage device 1002, and executes the processing described in each of the above exemplary embodiments according to the product detection program.

The auxiliary storage device 1003 is an example of a non-transitory tangible medium. Other examples of non-transitory tangible media include magnetic disks connected via the interface 1004, magneto-optical disks, Compact Disk Read Only Memories (CD-ROMs), Digital Versatile Disk Read Only Memories (DVD-ROMs), semiconductor memories, and the like. In a case where the program is distributed to the computer 1000 through a communication line, the computer 1000 that has received the distribution may develop the program in the main storage device 1002 and execute the above processing.

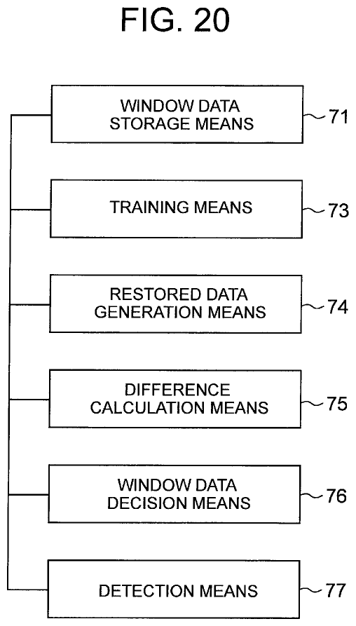

Next, an outline of the present invention will be described. FIG. 20 depicts a block diagram illustrating an outline of a product detection device of the present invention. A product detection device of the present invention includes window data storage means 71, training means 73, restored data generation means 74, difference calculation means 75, window data decision means 76, and product detection means 77.

The window data storage means 71 (e.g., window data storage unit 10) stores a plurality of pieces of window data, each of which is a pair of the size of the first window for extracting data from time series data of a normal product, the size of each of the second window and the third window for dividing data extracted using the first window into former part data and latter part data, and the slide size in sliding the first window.

The training means 73 (e.g., training unit 4) trains a model for recovering latter part data from former part data by using a set of pairs of former part data and latter part data obtained using the first window, the second window, and the third window from time series data of each of a plurality of normal products as training data, window data is sequentially selected.

The restored data generation means 74 (e.g., restored data generation unit 6) generates restored data of latter part data by applying former part data to the model for each pair of former part data and latter part data obtained based on the selected window data.

The difference calculation means 75 (e.g., difference calculation unit 8) calculates a difference between the latter part data obtained based on the selected window data and the restored data for each normal product.

The window data decision means 76 (e.g., window data decision unit 11) decides window data that satisfies a predetermined condition based on the difference calculated for each normal product.

The detection means 77 (e.g., product detection unit 13) detects a predetermined normal product from a plurality of normal products based on the difference for each normal product obtained based on the window data decided by the window data decision means 76.

It is possible with such a configuration to detect a normal product deviated from the normal pattern from normal products that have been determined to be normal.

Moreover, the difference calculation means 75 may calculate a plurality of differences between latter part data and restored data for each normal product and derive one product difference corresponding to a normal product based on a plurality of differences when one piece of window data is selected, the window data decision means 76 may select product differences, the number of which corresponds to a predetermined ratio to the number of normal products, from among product differences each derived for a normal product in descending order of product difference for each window data, define the first group to which the selected product differences belong and the second group to which product differences other than the selected product differences belong, calculate the variance of product differences belonging to the first group and the variance of product differences belonging to the second group, and decide window data based on the variance of product differences belonging to the first group and the variance of product differences belonging to the second group.

The window data decision means 76 may define a maximum value of the variance of product differences belonging to the first group for each window data as the ideal value of the variance of product differences belonging to the first group, define zero as the ideal value of the variance of product differences belonging to the second group, and decide window data based on the difference between the variance of product differences belonging to the first group and the ideal value of the variance, and the difference between the variance of product differences belonging to the second group and the ideal value of the variance.

The window data decision means 76 may define the maximum value of the variance of product differences belonging to the first group for each window data as Y, define the variance of product differences belonging to the first group corresponding to one piece of window data as y, define the variance of product differences belonging to the second group corresponding to the window data as x, calculate the distance between coordinates (0, Y) and coordinates (x, y) for each window data, and decide window data satisfying a condition that the distance is the minimum.

The detection means 77 may select product differences, the number of which corresponds to a predetermined ratio to the number of normal products, from among product differences for each normal product obtained based on the window data decided by the window data decision means 76 in descending order of product difference, and detect normal products corresponding to the selected product differences.

Display control means (e.g., display control unit 14) that displays the frequency distribution of product differences for each window data may be provided.

Although the present invention has been described above with reference to exemplary embodiments, the present invention is not limited to the above exemplary embodiments. The configurations or details of the present invention can be modified in various ways that can be understood by those skilled in the art within the scope of the present invention.

This application claims priority based on Japanese Patent Application No. 2018-059485 filed on Mar. 27, 2018, the entire disclosure of which is incorporated herein.

### INDUSTRIAL APPLICABILITY

The present invention is preferably applied to a product detection device that detects a product deviated from a normal pattern from products determined to be normal.

### REFERENCE SIGNS LIST

1 Time series data storage unit
2 Data segmentation unit
3 Divided data storage unit
4 Training unit
5 Model storage unit
6 Restored data generation unit
7 Restored data storage unit
8 Difference calculation unit
9 Product difference storage unit
10 Window data storage unit
11 Window data decision unit
12 Decided window data storage unit
13 Product detection unit
14 Display control unit
100 Product detection device

What is claimed is:

1. A product detection device comprising:
a window data storage unit that stores a plurality of window data, each window data being a combination of a size of a first window, a size of each of a second window and a third window, and a slide size for sliding the first window, wherein the first window is for extracting data from time series data of a normal product, and wherein the size of each of the second window and the third window is for dividing data extracted using the first window into former part data and latter part data;
a training unit that trains a model for restoring latter part data from former part data by using a set of pairs of former part data and latter part data obtained using the first window, the second window, and the third window from time series data of each of a plurality of the normal products as training data;
a restored data generation unit that generates restored data of the latter part data by applying the former part data to the model for each pair of the former part data and the latter part data, the each pair being obtained based on selected window data;
a difference calculation unit that calculates a difference between the latter part data and restored data obtained based on the selected window data for each normal product;
a window data decision unit that decides window data satisfying a predetermined condition based on a difference calculated for each normal product; and
a detection unit that detects a predetermined normal product from a plurality of normal products based on a difference for each normal product obtained based on window data decided by the window data decision unit.

2. The product detection device according to claim 1,
wherein the difference calculation unit calculates a plurality of differences between latter part data and restored data for each normal product and derives one product difference corresponding to a normal product based on a plurality of differences when one piece of window data is selected, and
the window data decision unit selects product differences, the number of which corresponds to a predetermined ratio to the number of normal products, from among product differences each derived for a normal product in descending order of product difference for each window data, defines a first group to which the selected product differences belong and a second group to which product differences other than the selected product differences belong,
calculates variance of product differences belonging to the first group and variance of product differences belonging to the second group, and
decides window data based on the variance of product differences belonging to the first group and the variance of product differences belonging to the second group.

3. The product detection device according to claim 2,
wherein the window data decision unit defines a maximum value of variance of product differences belonging to the first group for each window data as an ideal value of the variance of product differences belonging to the first group,
defines zero as an ideal value of variance of product differences belonging to the second group, and
decides window data based on a difference between variance of product differences belonging to the first group and the ideal value of the variance, and a difference between variance of product differences belonging to the second group and the ideal value of the variance.

4. The product detection device according to claim 2,
wherein the window data decision unit defines a maximum value of variance of product differences belonging to the first group for each window data as Y, defines variance of product differences belonging to the first group corresponding to one piece of window data as y, defines variance of product differences belonging to the second group corresponding to the window data as x, calculates a distance between coordinates (0, Y) and coordinates (x, y) for each window data, and decides window data satisfying a condition that the distance is minimum.

5. The product detection device according to claim 2,
wherein the detection unit selects product differences, the number of which corresponds to a predetermined ratio to the number of normal products, from among product differences for each normal product obtained based on window data decided by the window data decision unit in descending order of product difference, and detects normal products corresponding to selected product differences.

6. The product detection device according to claim 2, further comprising
a display control unit that displays frequency distribution of product differences for each window data.

7. A product detection method comprising:
receiving a plurality of window data, each window data being a combination of a size of a first window, a size of each of a second window and a third window, and a slide size for sliding the first window, wherein the first window is for extracting data from time series data of a normal product, and wherein the size of each of the second window and the third window is for dividing data extracted using the first window into former part data and latter part data,
training a model for restoring latter part data from former part data by using a set of pairs of former part data and latter part data obtained using the first window, the second window, and the third window from time series data of each of a plurality of the normal products as training data,
generating restored data of the latter part data by applying the former part data to the model for each pair of the former part data and the latter part data, the each pair being obtained based on selected window data,
calculating a difference between the latter part data and restored data obtained based on the selected window data for each normal product,
deciding window data that satisfies a predetermined condition based on a difference calculated for each normal product, and
detecting a predetermined normal product from a plurality of normal products based on a difference for each normal product obtained based on decided window data.

8. The product detection method according to claim 7, the product detection method further comprising:
calculating a plurality of differences between latter part data and restored data for each normal product and derive one product difference corresponding to a normal product based on a plurality of differences when one piece of window data is selected,
selecting product differences, the number of which corresponds to a predetermined ratio to the number of normal products, from among product differences each derived for a normal product in descending order of product difference for each window data, define a first group to which the selected product differences belong and a second group to which product differences other than the selected product differences belong,
calculating variance of product differences belonging to the first group and variance of product differences belonging to the second group, and
deciding window data based on the variance of product differences belonging to the first group and the variance of product differences belonging to the second group.

9. A non-transitory computer-readable recording medium in which a product detection program is recorded,
the product detection program being capable of causing the computer to execute:
a process of receiving a plurality of window data, each window data being a combination of a size of a first window, a size of each of a second window and a third window, and a slide size for sliding the first window, wherein the first window is for extracting data from time series data of a normal product, and wherein the size of each of the second window and the third window is for dividing data extracted using the first window into former part data and latter part data;
a training process of training a model for restoring latter part data from former part data by using a set of pairs of former part data and latter part data obtained using the first window, the second window, and the third window from time series data of each of a plurality of the normal products as training data;
a restored data generation process of generating restored data of the latter part data by applying the former part data to the model for each pair of the former part data and the latter part data, the each pair being obtained based on selected window data;
a difference calculation process of calculating a difference between the latter part data and restored data obtained based on the selected window data for each normal product;
a window data decision process of deciding window data that satisfies a predetermined condition based on a difference calculated for each normal product; and
a detection process of detecting a predetermined normal product from a plurality of normal products based on a difference for each normal product obtained based on window data decided in the window data decision process.

10. The non-transitory computer-readable recording medium according to claim 9, the product detection program being capable of causing the computer to:
calculate a plurality of differences between latter part data and restored data for each normal product and derive one product difference corresponding to a normal product based on a plurality of differences when one piece of window data is selected in the difference calculation process, and
select product differences, the number of which corresponds to a predetermined ratio to the number of normal products, from among product differences each derived for a normal product in descending order of product difference for each window data, define a first group to which the selected product differences belong and a second group to which product differences other than the selected product differences belong,
calculate variance of product differences belonging to the first group and variance of product differences belonging to the second group, and
decide window data based on the variance of product differences belonging to the first group and the variance of product differences belonging to the second group in the window data decision process.
